(19) United States
(12) Patent Application Publication
(10) Pub. No.: US 2004/0017400 A1
(43) Pub. Date: Jan. 29, 2004

(54) Method for project planning

(76) Inventors: Eric Thichvi Ly, Sunnyvale, CA (US); Michael A. Lenz, Mountain View, CA (US)

Correspondence Address: William J. Kolegraff, 3119 Turnberry Way, Jamul, CA, 91935, US

(21) Appl. No.: 10/205,736

(22) Filed: Jul. 26, 2002

(51) Int. Cl. G09G 5/00

(52) U.S. Cl. 345/810

(57) ABSTRACT

The method for project planning provides a process operating on a computer system that enables project planning information to be displayed and arranged in different display environments. First, the process provides a flexible data arrangement display environment. The data arrangement display enables generating and manipulating data objects in a manner that facilitates creativity, and may include graphically associating the generated data objects with defined categories. In this way, the project planning information may be entered, viewed, and categorized. Second, the process also provides a more traditional project planning environment having task lists, task attributes, and task schedules. The more traditional project planning display enables sophisticated analysis and manipulation of project planning information. By selecting a particular environment, the process converts the project planning information into a form for viewing and manipulation in the selected display.

The present invention claims benefit of priority to U.S. patent application Ser. No. 10/138,705 filed May 3, 2002, and entitled “Method for Graphical Classification of Unstructured Data” and to U.S. patent application Ser. No. 10/170,992, filed Jun. 13, 2002, and entitled “Method for Graphical Collaboration with Unstructured Date”, both of which are incorporated herein in their entirety.

### BACKGROUND

The field of the present invention is electronic processing systems and methods for entering, manipulating, and using data related to project planning.

Managing a projects or other undertaking can be a time-consuming and complicated task. Typically, managing a project entails detailing tasks to be performed, assigning personnel to perform the tasks, allocating resources, and setting and ordering priorities. Further, the project schedule is likely to change as the project progresses, or as others provide information related to the project. Such updating and managing may require substantial time and management effort.

To facilitate the project planning process, project planning computer applications are available to assist in collecting, viewing, and managing project information. A typical project planner accepts planning information to produce formal documents such as Gantt charts and PERT diagrams that facilitate project planning. These project planners generally create a task list, provide attributes for each task, and present a graphical representation of a schedule for performing the tasks. Additionally, these project planners may assist in setting priorities, allocating resources, and identifying a critical path.

Although the known project planning software are quite sophisticated and useful, it is undesirably difficult to enter the planning information into the project planning software. Further, once the planning information has been entered into the project planning program, the resulting display typically can only be manipulated by those sophisticated enough to operate the project planning software, which can be quite complicated. Accordingly, once the unstructured project planning data has been entered into the more structured planning program, it becomes more difficult for some of the most creative users to conveniently view and work with the data.

As described above, typical project planning displays are very structured and often require a high level of sophistication to use, understand, and manipulate. However, many individuals lack the training to effectively use such displays or simply do not need the sophistication or level of structure provided by the typical project plan. Further, some individuals simply are more effective working with data having less structure. For example, in working with highly unstructured data, it is common to use a chalkboard, whiteboard, or other informal mechanism to assist in generating, collecting, and presenting data. In this regard, the whiteboard or other data-receiving area is used to arrange and present individual pieces of data. Data may be written and arranged on the whiteboard, with individual pieces of data being erased and rewritten to facilitate a creative process. In another example, “sticky-notes” are used to capture individual data points, and then the notes are arranged on a note-receiving surface such as a whiteboard or corkboard. Moving and arranging such notes is easier and less time consuming than erasing and rewriting data directly on a whiteboard.

Although arranging notes on a whiteboard is conducive to creative and flexible idea generation, the whiteboard or other informal note arranging method is mostly ineffective in presenting complex project plans. Further, such whiteboard environments do not facilitate easy long term collection or analysis of the data. Accordingly, computerized brainstorming environments have been developed. For example, “sticky note” software operates to allow one or more users to place notes on a computer screen in an emulation of a whiteboard environment. In this regard, the “sticky note” software enables more efficient long-term collection of data. Also, general outlining software and other such brainstorming tools are available to facilitate the collection of unstructured data. However, such outlining and brainstorming software tend to have a single, inflexible interface that every user must adapt to, regardless of the individual needs of a user.

More generally stated, the sophisticated and formal structure of the project plan facilitates presentation and decision analysis. However, that very same formal structure often impedes creatively working with the plan information once the plan has been generated. This is especially true for certain types of individuals. For example, some individuals operate most efficiently with more free-form thought processes, while others operate better with a high level of structure. Unfortunately, the “structure” people will generally be ineffective in using the free-form brainstorming tools, while the “free-form” people will be stifled when they hit the formality of the project planners. Accordingly, both the brainstorming systems and the project planners provide an undesirably inflexible operating environment.

Therefore, there exists a need for a process operating on a computer that allows for the creative generation and viewing of plan information, but yet enables generation and use of formal project plans. Further, there exists a need for a method of providing a project plan that facilitates decision analysis, but in a way so that the planning display does not impede or interfere with the flexible and creative use of the planning information.

### SUMMARY

It is therefore an object of the present invention to provide a process operating on a computer system for project planning. It is a further object of the present invention that the project planning application provide a convenient and flexible interface for using planning information. Therefore, to overcome the deficiencies in the known systems and to meet the objects of the present invention, a method for project planning is provided.

Briefly, the method for project planning provides a process operating on a computer system that enables project planning information to be displayed and arranged in different display environments. First, the process provides a flexible data arrangement display environment. The data arrangement display enables generating and manipulating data objects in a manner that facilitates creativity, and may include graphically associating the generated data objects with defined categories. In this way, the project planning information may be entered, viewed, and categorized. Second, the process also provides a more traditional project planning environment having task lists, task attributes, and task schedules. The more traditional project planning display enables sophisticated analysis and manipulation of project planning information. By selecting a particular environment, the process converts the project planning information into a form for viewing and manipulation in the selected display.

In a specific example of the method for project planning, the data arrangement is provided as a metaphor for manipulating “sticky notes” on a “whiteboard”. Structure and detail information may be added by associating the notes with one or more categories, which each represent a high-level concept. More specifically, structure may be added to the sticky notes by graphically arranging the notes relative to a labeled axis. Varying levels of structure may be viewed by selectively adding or removing categories. The category and data note information represents project planning information, and may then be converted into a more traditional project plan, such as a GANTT or PERT chart. In another example, the project plan may be converted from the traditional project plan to the more flexible data arrangement. Finally, it may also be desirable to enable the concurrent viewing and manipulation of both the data arrangement and the project plan. In this way, modifications made in one environment are nearly simultaneously viewed and available in the other environment.

Advantageously, the method for project planning enables each user to work in an environment more suited for that particular user or task. For example, a user comfortable with sophisticated project planners may select to work in the more traditional project planning environment. At other times, it may be more efficient to work in the data arrangement environment where project planning information can be viewed and manipulated with varying levels of structure. Further, some users may find it most creative to work with no structure at all, and may choose to add and view data objects in a free form environment. In a multi-user system, each user may select to work in an environment suited for their particular task. Accordingly, some users may be using different variations of the data arrangement, and others may be using the project plan, but all users are able to collaborate. For example, modifications made by any user, in any environment, may be reflected almost immediately in the displays of the other active users.

### BRIEF DESCRIPTION OF THE DRAWINGS

FIG. 1 is a diagram of a project planning system;

FIG. 2 is a diagram of a free-form data arrangement;

FIG. 3 is a diagram of a two dimensional data arrangement;

FIG. 4 is a diagram of a one dimensional data arrangement;

FIG. 5 is a classification table;

FIG. 6 is a diagram of a method for project planning;

FIG. 7 is a project plan view of project planning information;

FIG. 8 is a diagram of a method of conversion;

FIG. 9 is a flowchart of a method for project planning;

FIG. 10 is a project plan view;

FIG. 11 is a flowchart of a method for project planning;

FIG. 12 is a project task list; and

FIG. 13 is a diagram of a method for project planning.

### DETAILED DESCRIPTION

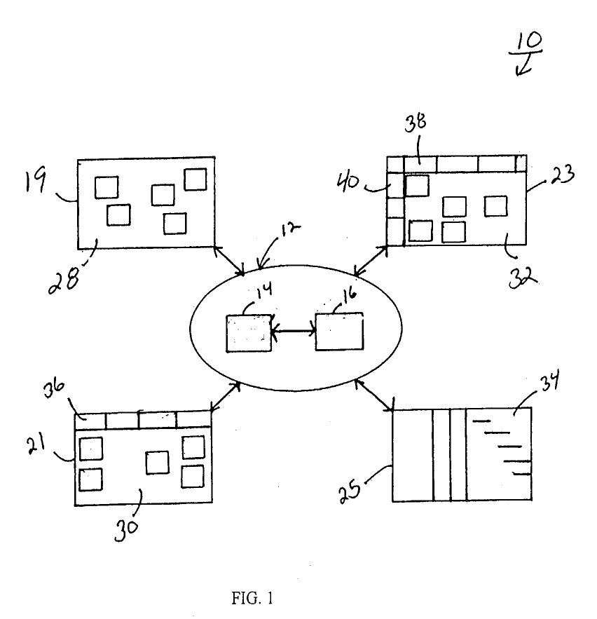

Referring now to FIG. 1 a project planning system 10 is shown. Project planning system 10 provides a project planner with flexible tools for inputting, arranging, viewing, and analyzing project-planning information. Project planning system 10 is generally constructed as an application for operation on a processing system such as an electronic computer system. It will be appreciated that the project planning system 10 could operate on a single computer system or may be distributed on multiple computers in a network environment. Further, project-planning system 10 could be implemented on a distributed network such as the Internet.

Project planning system 10 comprises a shared file system 12 holding project planning information. The project planning information may be arranged into classified data 14 or project data 16. Project data 16 facilitates using and viewing the project planning information in a traditional project plan format, such as project plan 34 displayed on data display 25. The project plan 34 enables sophisticated project planners to use and view project planning information in a familiar and highly structured environment.

However, the project planning information is also arrangeable in the classified data format 14. The classified data 14 enables the project planning information to be viewed with a varying level of structure. For example, the classified data 14 may be viewed in a data display 19 having an unstructured data arrangement 28. The unstructured data arrangement 28 includes a collection of data notes that may be freely moved about the display area. Such a freeform and unstructured arrangement facilitates generation, modifying, and arranging information in an unencumbered manner.

The same classified data 14 may also be viewed with additional selected structure. For example, classified data 14 may also be viewed on display 21 with a one-dimensional data arrangement 30. The one-dimensional data arrangement 30 has an x-axis segregated into columns, with each column having a label. In this way, each of the data notes may be graphically moved into a particular column to show an arrangement with one of the x-axis label of a category 36. In another example, classified data 14 may be displayed in data display 23 in the form of a two-dimensional data arrangement 32. Two-dimensional data arrangement 32 has an x-axis category 38 having a series of column labels, and a y-axis category 40 having a series of row labels. In this way, data notes may be graphically moved and arranged to be associated with the proper x-axis and y-axis category association. It will also be appreciated that additional structure could be added in the form of additional axis categories for a data display.

Advantageously, project-planning system 10 enables a project planner to use project planning information in the shared file system 12 in a highly flexible manner. For example, the data in the shared file system 12 may be used in a highly unstructured manner as in display 19, selected structure added to facilitate specific needs as shown in displays 21 and 23, or displayed in the highly structured and sophisticated project plan view as shown on display 25. In this regard, a project planner is able to use the project planning information with a desirable level of structure and sophistication. Further, the project planning system 10 facilitates convenient use of project planning information by multiple users. For example, each of the data displays 19, 21, 23, and 25 could represent different users accessing the shared file system 12 concurrently. Each of the users could structure their respective display to use the information in a manner most comfortable and efficient for that particular user. For example, a highly sophisticated project planner may feel most comfortable and efficient operating in a project view 34, while a user interested only in cost may prefer working with a one-dimensional arrangement highlighting cost information, as would be possible in a one-dimensional view 30. In this regard, project-planning system 10 facilitates a highly efficient and advantageous collaborative planning system.

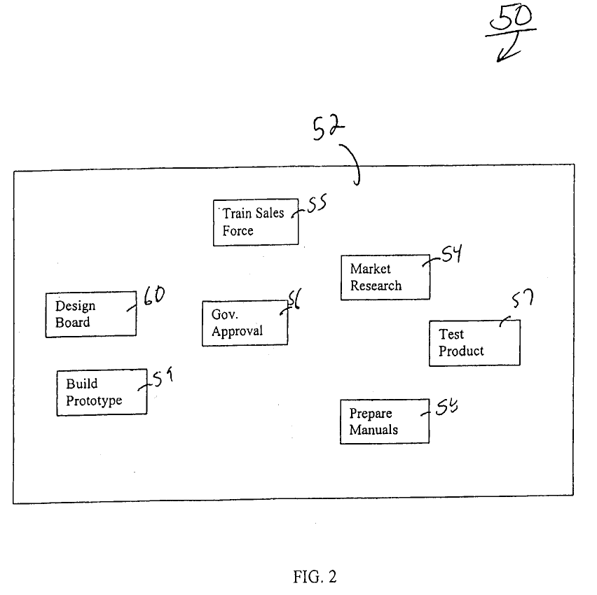

In FIG. 2, a computerized process facilitating graphical classification of unstructured data is illustrated. FIG. 2 shows the process emulating the familiar “whiteboard” environment, and enables a user to generate, place, and move simulated “sticky-notes” on the whiteboard. The unstructured data is presented as “sticky-notes”, or text boxes, that can be freely moved about the whiteboard display area. Such a free-form process for generating, moving, and viewing data facilitates a creative and efficient brainstorming environment. The process, therefore, uses the whiteboard and sticky-note as efficient and comfortable metaphors to develop a graphical user interface. However, the electronic process enables a level of creatively, synthesis, and analysis not available using known systems. It will be appreciated that although the process of FIG. 2 is styled after the traditional whiteboard and sticky-note, other useful metaphors may be substituted consistent with this disclosure.

The whiteboard environment 52 typically is displayed on a computer screen, and is manipulated with common graphical input devices, such as a mouse. Data objects may be added into the whiteboard area 14. In a particular example, the data objects may be in the form of notes such as notes 55-60. It will be appreciated that additional notes may be added by graphical interaction with the data arrangement area 52, or by other accepted means.

Advantageously, a user may interact with the notes 55-60 in a freeform and creative way. In this regard, a user may use a graphical interaction device, such as a mouse or other pointing device to arrange, add, and delete notes to facilitate a creative thought process. Indeed, the electronic process is constructed to advantageously use graphical interactions, such as dragging and dropping functions, for facilitating ease of use and efficient interactions.

Although whiteboard area 52 is shown to be of limited size, it will be appreciated that the whiteboard area 52 may be of varying sizes. For example, the whiteboard presentation may allow for vertical or horizontal scrolling to allow a great number of notes to be presented on a single whiteboard. It will also be appreciated that although the data arrangement area is shown in the form of a whiteboard simulation, that other freeform data input areas are contemplated.

The whiteboard area 52 may provide various familiar tools to facilitate adding additional notes. For example, the whiteboard area 14 may allow for grids, snaps, and glue for more conveniently arranging notes. It will also be appreciated that notes may be added of different size and of different format. For example, some notes may be purely textual, while others may contain numbers, graphics, sound, or video. The whiteboard environment 52 may also provide for linking notes together, such as with lines or other connection mechanisms. At a later time, such connections may be used to track relationships between notes.

Although the whiteboard area 52 enables a flexible and convenient way to view and manipulate unstructured data, it may be useful to enable the user to add additional structure to facilitate organization and analysis. For example, the data may be synthesized to establish relationships and connections with higher-level concepts. More particularly, the process of synthesizing may be considered a process of categorizing the data according to defined criteria. Using the graphical whiteboard environment, a user associates individual data objects, such as data notes, with regard to defined categories.

A category relates to a particular high-level concept for the data. For example, “priority” may be a high-level concept that can be assigned to a category. The “priority” category may be further defined by providing a set of available “labels” for the category. For example, labels for the priority category may set aspects of the high-level concept to be “high”, “medium”, and “low”. The whiteboard environment 52 may provide a set of predefined categories, with each category having predefined labels. The whiteboard environment 52 may also provide for the customization of the predefined categories and labels, and may further provide for the creation of new categories and associated labels.

Data display 50 is shown which is similar to data display 19 described in FIG. 1. Data display 50 is arranged as a free form data arrangement 52. The free form data arrangement 52 has multiple data notes positioned on the display. For example, data display 50 shows a market research data object 54, a train sales force data object 55, a government approval data object 56, a test product data object 57, a prepare manual data object 58, a billed product data object 59, and a design board data object 60. In one example of the free form data arrangement 52, the free form data arrangement 52 is configured as a metaphor for a white board environment. The data objects are graphically generated and positioned on the white board using a sticky note metaphor. In this regard, the free form data arrangement 52 mimics the physical white board with sticky notes adhered to its surface. Such a white board and sticky note environment facilitates creative brainstorming, and is a comfortable metaphor for generating and working with project information. In free form data arrangement 52, each of the data notes may represent an activity for a hypothetical product plan. More specifically, each of the specific activities appears as a label on an associated data note. Using the free form data arrangement 52, a user may freely add, move, and modify data notes according to individual preferences.

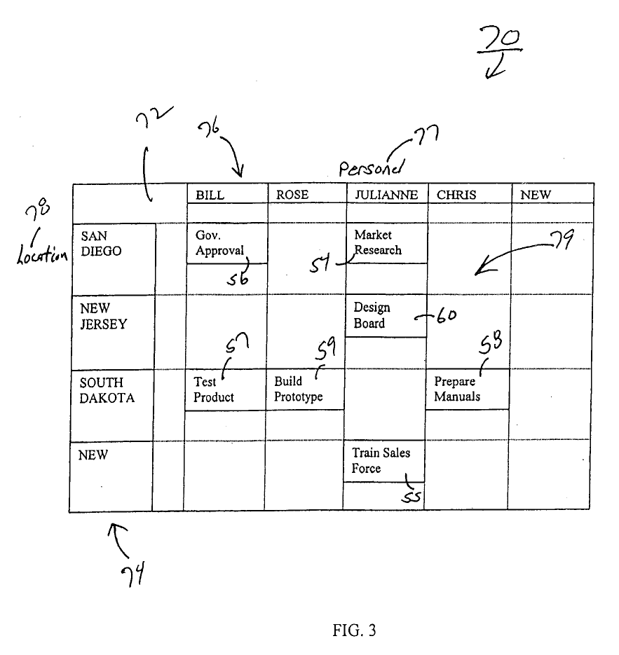

Referring now to FIG. 3, a data display 70 is shown. Data display 70 is similar to data display 23 described in regard to FIG. 1. Data display 70 has a two-dimensional data view 72 having a “personnel” category 77 on its x-axis and a “location” category 78 on its y-axis. The x-axis category 77 is segregated into a series of columns, with each of the columns having an associated x-axis label 76. For example, the personnel category 77 has a “Bill” label, a “Rose”, a “Julianne”, and “Chris” label, with each label associated with a column. Personnel category 77 also has a “new” label where unclassified data notes could be placed. Further, the “new” label is where data notes would first appear prior to their initial association. The location category 78 is segregated into a series of rows, with each row having an associated y-axis label. For example, location category 78 has a “San Diego”, a “New Jersey”, and a “South Dakota” label. The location category 78 also has a “new” category where new or unassociated data notes would be viewed.

By moving a particular data note into a particular cell location, that particular data note can be associated with two categories simultaneously. For example, the market research data note 54 has been moved to show that the market research activity will be performed by Julianne in the San Diego location. In a similar manner, each of the other activities 79 has been moved into its associated cell location. In another example, the “train sales force” data note 55 will also be performed by Julianne, but the location has been left uncategorized. Although data display 70 has been shown having two categories of structure, it will be appreciated that more or fewer categories can be selected. Further, it will be appreciated that a particular user may select or add different categories depending upon different needs of that particular user.

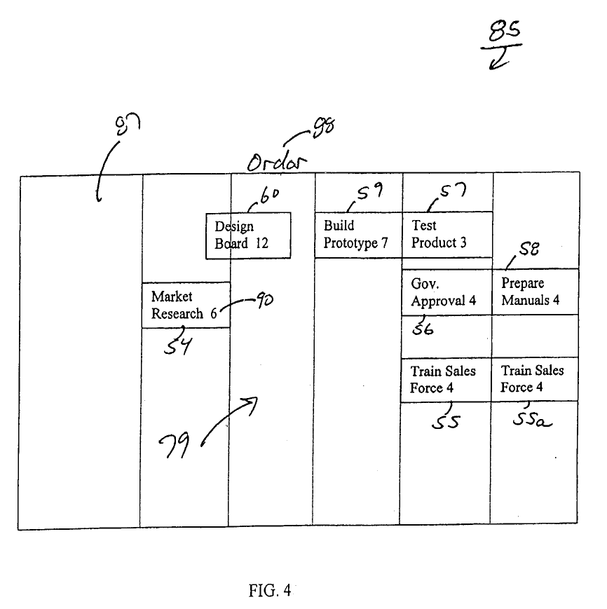

Referring now to FIG. 4, a data arrangement display 85 is shown with the activities 79. FIG. 4 illustrates the data arrangement being used to add dependency data to the data items. It will be appreciated that other methods of defining dependency data may be used, and that certain dependency data can be determined from existing associations. For example, if a resource is associated with several data objects, and it is assumed that the resource can only work on one data object at a time, then the data objects must not overlap in time. Although some dependency data may be initially made by setting assumptions and defining dependency rules, it also may be desirable to permit a user to add or modify particular dependency data.

Data display 85 is arranged as a one-dimensional data view 87 with a single x-axis category of “order” 88. The order category is useful to set a desired ordering between data objects. Accordingly, the order category assists in defining dependencies between data objects. It will be appreciated that other categories could be defined and associated with data objects to assist in setting dependencies. Even though each of the activities 79 retains the associations as set in FIG. 3, data display 85 provides an unencumbered view of the activities 79 to facilitate setting dependencies between the activities. Although not shown in FIG. 4, it will be appreciated that each of the columns could have an associated column label. For example, each of the columns could represent a one month time period. In another example, the order labels could represent a sequential order. In FIG. 4, each of the activities 79 has been arranged to show dependencies between labeled activities. For example, the “design board” data note 60 can start after the “market research” 54 is about three-quarters complete. The “build prototype” 59 cannot start until “design board” 60 is completed. “Test product” 57 and “government approval” 56 can occur simultaneously, while “train sales force” 55 can occur concurrently with “government approval” 56 and “prepare manuals” 58.

The “train sales force” data note 55 has been duplicated into “train sales force” data note 55a, showing that the particular activity can extend into two different columns. Although data display 85 shows a particular graphical method of showing dependencies between data notes, it will be appreciated that textual and other methods of setting dependencies may be used. It will also be appreciated that certain known software aids may be used to facilitate more efficient manipulation of the activities 79. For example, the data display 85 could have a “snap” facility so that each movement of a particular data note would move its position a distance set to one week. Further, it may be possible to adjust the size of each data note to more accurately reflect its actual duration. In another example, the duration could be entered as a textual number. In FIG. 4, the “market research” data note 54 shows that a duration 90 has been set at “6”. In a similar manner, each of the activities 79 has an associated weight or duration that has been textually added to each of the data notes. It will be appreciated that more than one textual weight may be added to each data note, and that the textual weight factor may represent different project planning criteria. For example, the weight could represent a duration unit, a cost unit, or a relative criticality to the project.

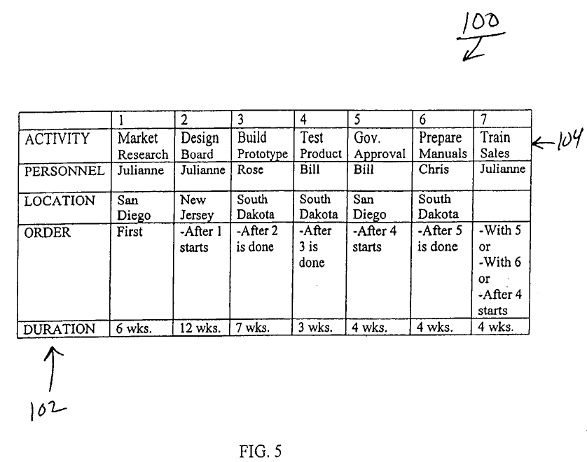

Referring now to FIG. 5, a classification table 100 is described. Classification table 100 is an illustration of one format for saving the associations defined using the data arrangements. More particularly, classification table 100 may be the format for the classified data as described with FIG. 1. Classification table 100 positions each of the categories that was defined in the data arrangement into column 102, with each category becoming a label for a row. For example, the “personnel” category is shown as the label for its associated row. In another example, each of the data notes that was defined in the data arrangement is positioned in a row with the “Activity” category. In this way, each of the data notes 104 is also a heading for a column. For example, the “market research” activity label is a column heading for column number 1. With categories set as row labels, and data notes set as column labels, cells of the table indicates particular associations between a data note and a label for a category. For example, the “Design Board” data note is associated with the “Julianne” label for the “Personnel” category, and with the “San Diego” label for the “Location” category. The “duration” defined in FIG. 4 has also been included as a category, and the task detail indicates the duration as set previously for each activity. It will be appreciated that classification table 100 is just one of several methods available to store and maintain classification data. For example, classification data may also be maintained in a database, such as a flat file system or in a relational database.

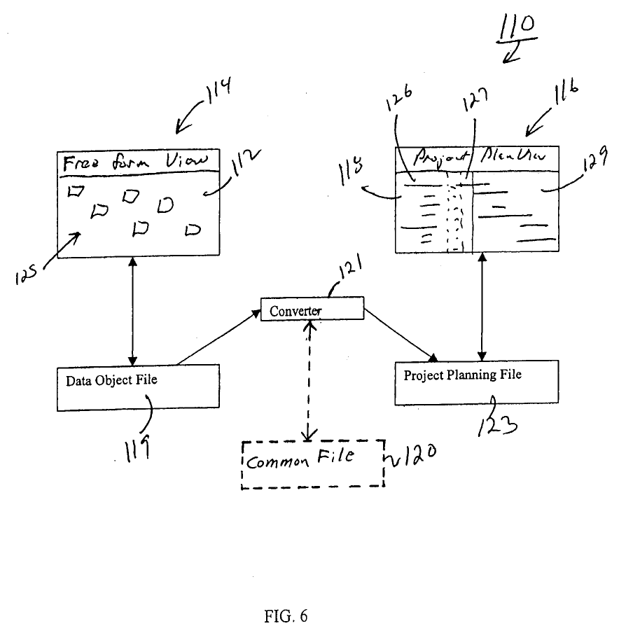

Referring now to FIG. 6 a method for project planning 110 is shown. Method for project planning 110 includes multiple data displays, such as data display 114 and data display 116. Data display 114 is configured to show a free form data view 112. Free form data view 112 includes data notes 125 similar to those previously described. Information regarding the data objects 125 may be stored in a data object file 119. Data objects file 119 may be similar, for example to classification data table 100 described earlier. Free form data view 112 may be viewable as an electronic metaphor for a white board with sticky note arrangement. Additionally, the data display 114 may be configured to add additional structure by assigning categories to rows or labels. In this regard, a user may graphically and conveniently add, modify, or view structure associated with the data notes.

Information from the data object file 119 may be received into a converter 121. Converter 121 is a process application for accepting information from the data object file 119 and formatting the data into an arrangement consistent with a project-planning file 123. Further, the converter may generate data that is used to initially set selected elements in the project-planning file. For example, the converter 121 may have a set of rules that determine a pre-defined set of dependencies based on resource allocation retrieved from the data object file. More detailed information regarding converter 121 will be described in a later section.

The project-planning file 123, which contains information indicative of the data object file 119, is used to provide information to data display 116. Data display 116 is configured to display a project planning view 118. The project plan view 118 includes a task list 126 which lists particular tasks to perform during the project, one or more columns 127 providing detail information for the task, and a schedule area 129 that graphically displays relationships between tasks. It will be appreciated that project-planning file may take alternative forms, such as a flat file, a table, or a relational database, for example. Also, it will be appreciated that other conversion sequences may be used. For example, method 110 could contain a common file 120 for storing both data object and project planning information. In this regard, the converter 121 would extract and format a particular subset of information when formatting the data view 112, and would extract and format another particular subset of information when formatting the project planning view 116. Accordingly, the data view and the project-plan view are consistent, with each particularly arranged to facilitate efficient understanding and use of the project information.

Advantageously, a user may generate data notes in the convenient and unstructured view, such as data view 112, and may further graphically add and view structure. Although the data view 112 is convenient and flexible for adding, modifying, and viewing certain levels of structure, it may be desirable to prepare a formal project plan view. Accordingly, the information from the data object file can be converted and displayed onto a more formal project plan.

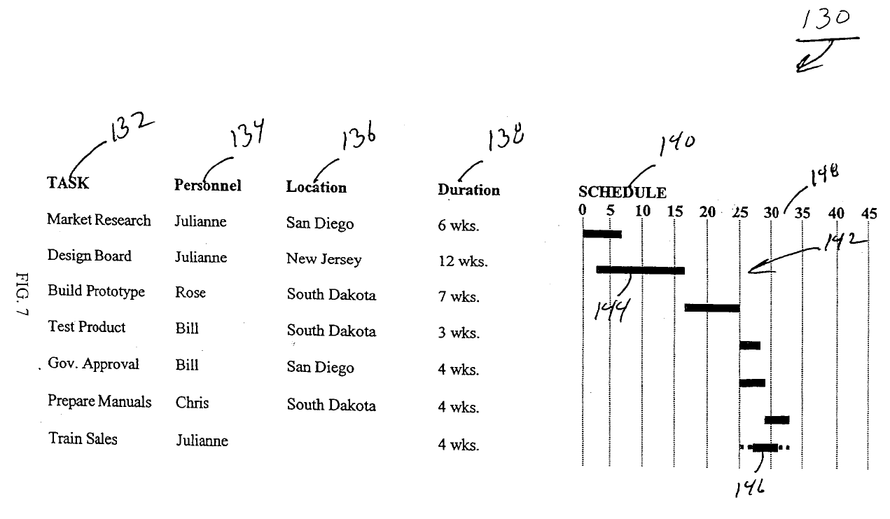

FIG. 7 shows more detail as to a more formal project plan. Project plan 130 is generally in the form of a Gantt chart. It will be appreciated that although project plan 130 is shown in the form of a Gantt chart, that other formal project plans could be substituted, such as a PERT or critical path chart. Project plan 130 includes a task list 132 with columns 134, 136, and 138 adding particular detail to each task. A schedule area 140 is used to show schedule and relationships between the list of tasks. Schedule relationships are shown using task bars 142. A schedule scale 148 may be used to show relative timing, such as weeks or months.

The task list 132 has entries setting forth specific tasks to be performed in the project. The task list may also contain a hierarchical structure to assist in viewing and modifying more complicated plans. For example, the task list may have one or more parent tasks that act as a higher-level organizational element. In this regard, several individual tasks may be associated with each parent task. Often, these individual tasks are referred to as “leaf tasks”. It will also be appreciated that the parent task may represent only a heading function, or the individual leaf tasks may aggregate associations for the parent task entry. For example, the parent task may show an aggregated resource required to perform all the leaf tasks in that parent task. Also, more than one level of organizational structure may be provided. For example, a parent task may have sub tasks, with leaf tasks associated with each sub task.

FIG. 7 shows that labels associated with data notes may become tasks in the task list 132. For example, the “market research” and “design board” activity labels have now become individual tasks in task list 132. Categories, such as the “personnel” category 134 have become a heading for a column in the project plan. Each of the associations set in the category now appear as detail for the project plan. For example, the “market research” task is to be performed by Julianne in San Diego and will have a duration of six weeks. The six week duration also appears in the schedule area 140 as an elongated bar. Note that the “design board” task starts while the “market research” task is active, but the “build prototype” activity is not allowed to start until the completion of the “design board” task. The schedule area 140 also shows that the “train sales” task can start concurrently with “test product” or the “government approval” task, and is allowed to extend to the end of the “prepare manuals” task. However, the task bar 146 is sized to represent four weeks in duration, but is allowed to float in an eight-week period. Advantageously, the information from the previously defined data notes have been converted to a traditional and more formal project plan view 130.

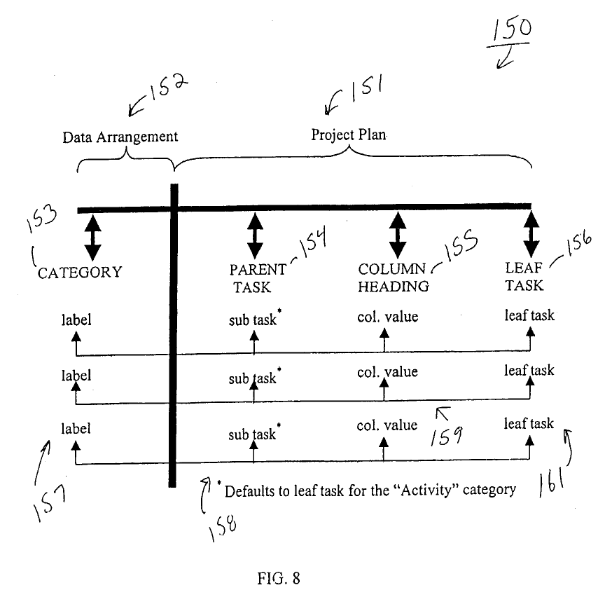

Referring now to FIG. 8, a method of conversion 150 is described. More particularly, FIG. 8 illustrates conversion relationships between elements in a data arrangement 152 and elements in a project plan 151. The elements of the data arrangement 152 may be similar to the elements in the data arrangement view 112 (FIG. 6), while the elements in project plan 151 may be similar to the elements in project plan view 118 (FIG. 6). As illustrated in FIG. 8, each category 153 in the data arrangement may be assigned to be an element in the project plan 151. The assignment may be made according to systematic rules, or by user selection. More specifically, each category can be assigned to be a parent task 154 in the task list, a column heading 155 for displaying task attributes, or a leaf task in the task list. It will be appreciated that not all categories need to be converted and displayed in the project plan. Instead, the system or a user may make decision on the level of detail and type of information to display in the project plan.

Depending on the assignment for a category, the labels for that category are initially assigned to be specific elements in the project plan. For example, if a category 153 in the data arrangement 152 is assigned to become a parent task 154 in the task list of the project plan, the associated labels 157 for that category become sub tasks 158 to that parent task in the task list. These sub tasks are typically used to provide an organization and structure to specific leaf tasks. Although most categories have their labels default to sub tasks, the “Activity” category has a different default setting. As describer earlier, the “Activity” category has labels that are indicative of the data notes in the data arrangement. Accordingly, the labels for the “Activity” category default to be leaf tasks in the task list. It will be appreciated that although the method 150 provides default settings, the user may be able to flexibly assign or reassign each label to achieve specific views of the project planning information.

If a category 153 in the data arrangement 152 is assigned to become a column heading 155 in the project plan, the associated labels 157 for that category become task attributes 158 in the project plan. These task attributes will be displayed as column values, and may be include either textual or numerical information. Finally, if a category 153 in the data arrangement 152 is assigned to become a leaf task 156 in the task list of the project plan, the associated labels 157 for that category become leaf tasks 161 in the task list for the project plan. It will be appreciated that the conversions may be responsive to user input, or may be responsive to predefined conversion rules. Further, process wizards, robots, or other assistance tools may be used to assist the user in making the conversion.

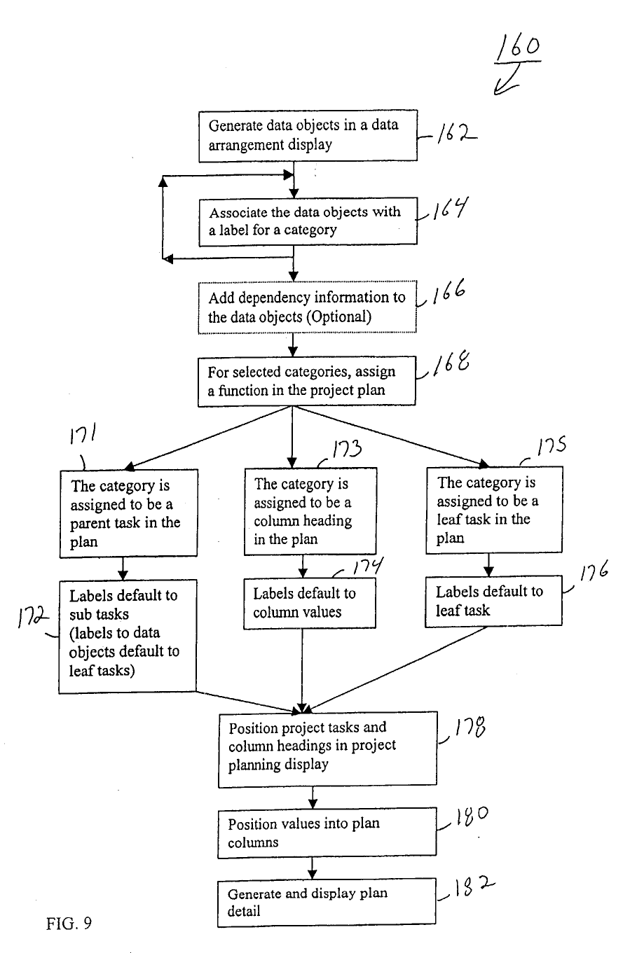

Referring now to FIG. 9 a method for project planning 160 is described. The method 160 generally implements the method shown with regard to FIG. 6. Project planning method 160 has data objects generated in a data arrangement display as shown in block 162. These data objects may be data notes generated and manipulated in a free form environment as previously described. The data objects or data notes are associated with one or more high level categories as shown in block 164. Optionally, dependency information may be added to the data notes in block 166. For example, dependencies may be added in a textual manner or may be added using a graphical ordering technique. Alternatively, initial dependencies may be set according to the associations already set for the data objects. For example, some initial dependencies could be set by assuming that earlier created data objects precede later generated data rules. Although this would typically not generate completely accurate dependencies, it may provide a convenient starting point for user modification. In another example, a rule could be set that assumed that a resource could only be allocated to one data object at a time. Accordingly, two data objects associated with the same resource could not occur concurrently. Of course, the user could adjust the dependencies in the project plan.

In block 168, categories from the data arrangement are selected for particular functions in the project plan. For example, a category from the data arrangement may be assigned to be a parent task in the task list of the project plan (block 171). If a category is assigned to be a parent task, then each of the associated labels for that category are initially set as sub tasks to that parent task, as shown in block 172. However, the labels for the “Activity” category default to be specific leaf tasks in the task list. A category may also be assigned to be a column heading in the project plan (block 173). If a category is assigned to be a column heading, then each of the associated labels for that category are initially set to be values in that column, as shown in block 174. In this regard, the labels become specific task attributes to selected task list entries. Finally, a category may also be assigned to be a leaf task in the project plan (block 175). If a category is assigned to be a leaf task, then each of the associated labels for that category are initially set also to be a leaf task in the task list of the project plan, as shown in block 176. Assignments for the categories and labels may be made directly by a user, or may have a level of automation based on predefined rules. For example, the method could initially set all data objects to be leaf tasks, and build a project plan with every other category initially set as a column heading. After the default plan was generated, a user could remove unwanted columns, and amend the task list. Alternatively, the method may provide a project plan wizard that assists the user in initially generating the project plan. For example, the wizard could lead a user through a series of inquiries where the user would select which categories to set as parent tasks, which to set as column headings, and which to set as leaf tasks. If desired, the wizard could also allow the user to select which labels or range of labels are used as task attributes. It will be appreciated that the wizard could be configured to operate in several alternative ways and be consistent with the sprit of this disclosure.

The project plan is configured in block 178, with the project tasks and column headings positioned for display. In block 180, detail is added into each of the category columns. In this regard, particular associations are described for each task item as shown in block 180. The plan schedule is completed and displayed as shown in block 182. Dependency information, whether received from a user or generated according to predefined rules, may be used to generate a plan schedule, which may be displayed on the display plan.

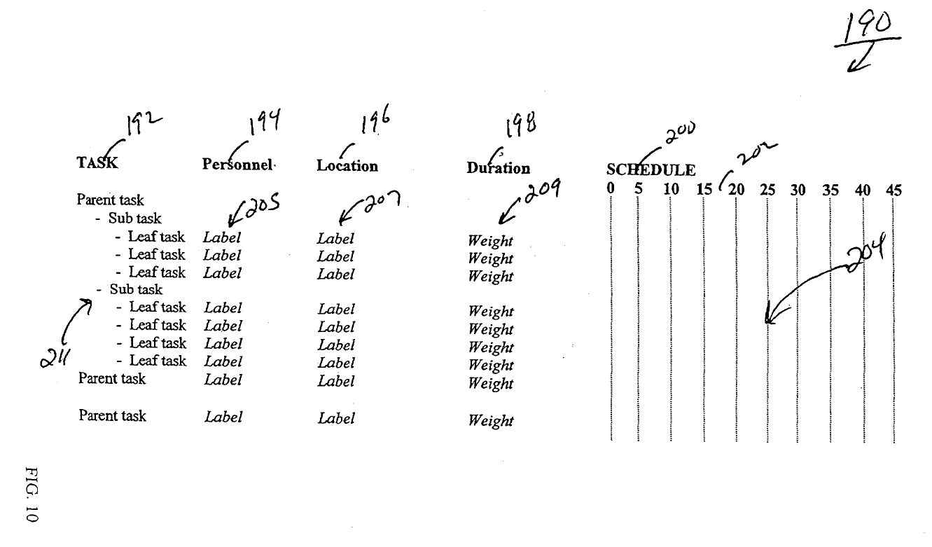

Referring now to FIG. 10, a project plan 190 is shown consistent with project plan method 160. Project plan 190 has a task list 192 which includes parent tasks, sub tasks, and leaf tasks. Tasks 211 may be hierarchically displayed with earlier tasks presented first and subsequent tasks presented later. Although leaf tasks have generally been associated with particularized tasks information and schedule, sub tasks and parent tasks may also have associated labels and weights. Project plan 190 shows that each of the tasks 211 originated as a label on a data note in a data arrangement. The data notes were selected to be parent tasks, sub tasks, or leaf tasks. Previously defined categories have now become columns for the project plan 190. For example, the “personnel” category is now column heading 194, the “location” category is now column heading 196, and the “duration” category is now a column heading 198. Each of the labels 205 in the personnel category are the specific associations made for each associated data note. In a similar manner the labels 207 in the “location” column 196 are the particular category associations made for location, and the weight identifiers in the “duration” column 198 are the particular durations input into each respective data note. Dependency information and duration information is used to generate the schedule 200. The schedule 200 generally comprises a series of bars placed in the task bar area according to the schedule scale 202.

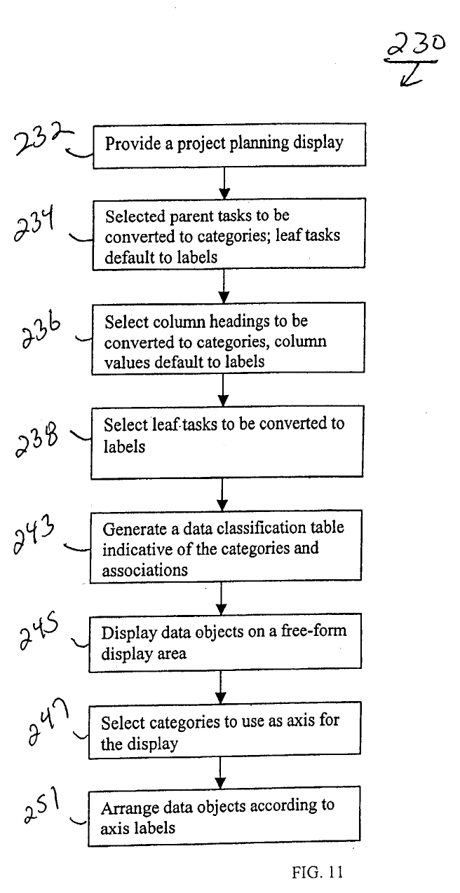

Referring now to FIG. 11, a method of viewing a project plan 230 is shown. Method 230 starts by providing a project planning display, such as the project plan 130. In block 234, selected parent tasks in the project plan are assigned to be categories in the data arrangement, with leaf tasks for each particular parent task initially being set as labels for the related category in the data arrangement. In block 236, selected column headings in the project plan are assigned to be categories in the data arrangement, with task attributes for each particular column initially being set as labels for the related category in the data arrangement. In block 238, selected leaf tasks in the project plan are converted to labels in the data arrangement. For example, some or all of the leaf tasks in the project plan task list can be converted to be data objects in the data arrangement.

With the categories and labels assigned, a classification table can be generated, as shown in block 243. The data classification table in block 243 may be similar to data classification table 100 described earlier. With the data classification table generated, the data notes may be displayed in a data arrangement. For example, the data notes may be displayed in a free form display area as shown in block 245. Further, the data arrangements may select one or more categories to use to view the data notes. For example, one or more categories may be selected to segment the x-axis as shown in block 247, and the data notes may be arranged to view according to the predefined association. It will also be appreciated that additional categories may be added in the data arrangement view.

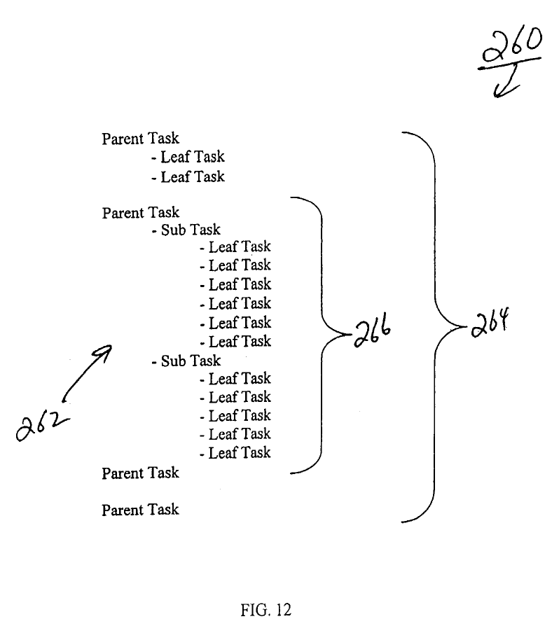

In viewing a project plan, it may be desirable to view or work on less than the entire project. For example, FIG. 12 shows a project having a task list 260. Task list 260 may include a multitude of tasks 262. In this regard, the entire project may be represented by the full task list 264. It may be useful, however, to work on a partial task list 266. Using a method similar to method 230, the partial task list 266 may be converted into data note form for viewing and manipulation in a data arrangement. In this way a project planner may focus attention on a particular sub section of the project plan for view and manipulation using the data arrangement displays.

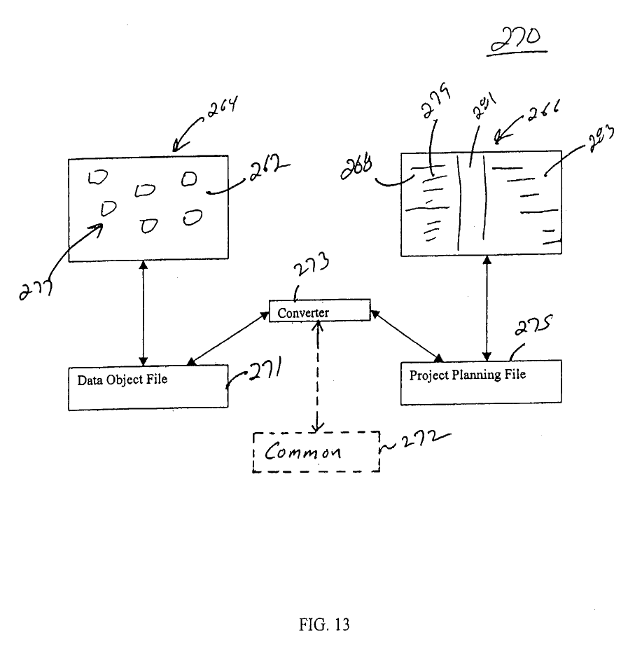

Referring now to FIG. 13, another method for project planning 270 is shown. Method for project planning 270 includes a data display 264 having a free form data view 262. The free form data view 262 includes data objects in the form of data notes 277. Information regarding the data arrangement of data view 262 is stored in a data object file 271. Method 270 also has a data display 266 showing a project plan view 268. Project plan view 268 includes a task list 279 having identifier columns 281. Further, the project plan view 268 also includes a schedule area 283 where task bars set for the relative timing and duration of the tasks.

Information regarding the project plan view 268 may be stored in a project-planning file 275. A converter 273 communicates and transfers information between the data object file 271 and the project-planning file 275. In this way, changes made in the data view 262 may be reflected in the project plan view 268, and changes made in the project plan view 268 may be viewed in the data view 262. A common file 272 may be used to facilitate the conversion process. The converter may be configured to operate so that the project plan view 268 and the data view 262 may be viewed concurrently. In this way changes made in either display can be substantially simultaneously displayed in the other display. It will be appreciated that certain systematic delays may occur, such as transmission and computation time, which may cause the updates to occur a short time after a change was made in a display.

It will also be appreciated that the converter 273 may account for simultaneous changes in each display to the same information. Such conflicts may be avoided using known techniques, such as record locking. For example, when a user in the data view 262 desires to make a change to a particular data note, the record associated with that data note could be locked in both the data object file 271 and the project planning file 275 until after the change has been made in the data view 262. In this way, if another user attempts to modify information regarding that data note, the user would be notified that the record is currently locked. It will also be appreciated that other methods for transactional conflict resolution are well known.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A method for project planning, comprising:
generating data objects in a data arrangement;
associating the data objects according to category labels, each category representing a higher-level concept;
converting at least some of the data objects to be entries in a task list;
converting at least some of the category labels into task attributes for their respective task list entries;
generating a task schedule; and
displaying a project plan using the task list, the task attributes, and the task schedule.

2. The method according to claim 1 further including displaying the data arrangement and the project plan concurrently.

3. The method according to claim 1, further including receiving modification information in the data arrangement, the modification information indicating a change to one of the data objects or the addition of another data object.

4. The method according to claim 3, wherein the modification information is used to update the entries in the task list, the task attributes, and the task schedule, and the updates are displayed in an updated project plan.

5. The method according to claim 4, where the updated project plan is displayed substantially simultaneously with the receiving of the modification information.

6. The method according to claim 1, further including receiving modification information in the project plan, the modification information indicating a change to the task list, the task attributes, or the task schedule

7. The method according to claim 6, wherein the modification information is used to update the data objects and the update is displayed in an updated data arrangement.

8. The method according to claim 7, where the updated data arrangement is displayed substantially simultaneously with the receiving of the modification information.

9. The method according to claim 1, where generating the task schedule includes automatically setting initial dependencies by analyzing the category labels associated with the data objects.

10. The method according to claim 1, wherein the data arrangement is configured as a free-form data arrangement, and the data objects are configured as data notes.

11. The method according to claim 1, wherein the data arrangement is configured to represent a free-form data arrangement and presented as a whiteboard metaphor, and the data objects are configured as data notes, and presented as a sticky-note metaphor.

12. The method according to claim 1, further including displaying the category labels on an axis of the data arrangement, and graphically associating the data objects to the category labels.

13. A method for project planning, comprising:
generating a project plan with at least a task list a column heading, task attributes, and a task schedule;
converting at least some entries in the task list into data objects;
converting the column heading into a category;
converting at least some of the task attributes into category labels for the category;
associating the data objects to the category labels, the category representing a higher-level concept; and
displaying the data objects in a data arrangement.

14. A method for project planning, comprising:
providing a common file arrangement that includes project information;
arranging the project information into data objects, the data objects including activity information, being associated with category labels, and having dependency data;
displaying the data objects in a free-form data arrangement;
arranging the project information into a project plan that includes task entries, task attributes, and a task schedule; and
displaying the project plan.

15. The method according to claim 14, including displaying the free-form data arrangement and the project plan concurrently.

16. The method according to claim 14, including having a change made in one of the displays update the other display substantially simultaneously.

17. The method according to claim 14, further including converting between activity information and task list entries.

18. The method according to claim 14, further including converting between category labels and task attributes.

19. The method according to claim 14, further including converting between dependency data and task schedule entries.

20. A method for project planning, comprising:
generating sticky-notes on a display using a whiteboard metaphor, each sticky-note including activity data;
displaying category labels on an axis of the display, and associating graphically the sticky-notes to the category labels, the category representing a higher-level concept;
converting the activity data from some of the sticky-notes to be entries in a task list;
converting the category labels into task attributes for their respective task list entries; and
displaying a project plan using the task list and the task attributes.

21. The method according to claim 20 further including displaying the whiteboard display and the project plan concurrently.

22. The method according to claim 20, wherein when a modification is made in either the whiteboard display or the project plan display, a change indicative of the modification is represented in the other display.

23. The method according to claim 22, wherein the change indicative of the modification is shown substantially simultaneously with when the modification is made.

24. A method for project planning, comprising:
providing a common file arrangement that includes project information;
arranging the project information into sticky-notes, the sticky-notes including activity information, being associated with category labels, and having dependency data;
displaying the sticky-notes in a free-form whiteboard arrangement;
arranging the project information into a project plan that includes task entries, task attributes, and a task schedule; and
displaying the project plan.

25. The method according to claim 24, further including converting between activity information and task list entries.

26. The method according to claim 24 further including converting between category labels and task attributes.

27. The method according to claim 24, further including converting between dependency data and task schedule entries.
